(19) United States
(12) Patent Application Publication
(10) Pub. No.: US 2009/0023025 A1
(43) Pub. Date: Jan. 22, 2009

(54) Passive Coolant Recirculation in Fuel Cells

(76) Inventor: Anders Risum Korsgaard, Aalborg (DK)

Correspondence Address: JAMES C. WRAY, 1493 CHAIN BRIDGE ROAD, SUITE 300, MCLEAN, VA, 22101, US

(21) Appl. No.: 11/991,973

(22) PCT Filed: Sep. 5, 2006
(86) PCT No.: PCT/DK2006/000490

§ 371 Date: Jun. 25, 2008

(30) Foreign Application Priority Data
Sep. 13, 2005 (DK) PA 2005 01275

(51) Int. Cl. H01M 8/04

(52) U.S. Cl. 429/26

(57) ABSTRACT

The present invention relates to the cooling of fuel cells in general. A fuel cell is placed inside or outside a liquid heat reservoir. The generated heat from the fuel cell increases the natural convection in the cooling flow channels of the fuel cell stack, passively recirculating the cooling water.

### FIELD OF THE INVENTION

The present invention relates to fuel cells as well as fuel cell stacks and the cooling thereof.

### BACKGROUND OF THE INVENTION

Fuel Cells are believed to be one of the most important energy technologies in the future energy system ranging from application areas such as transportation to stationary power generation. The central component in a fuel cell is the electrolyte enabling effective proton transport capability while being non-electrically conductive. The electrolyte also effectively separates the anode, which contains the fuel, and the cathode, containing the oxidant. In the case of the PEM (Polymer Electrolyte Membrane) fuel cell, the electrolyte is typically made of Nafion™ manufactured by Dupont®. Hydrogen is typically fed to the anode and air to the cathode compartment. This reaction produces water on the cathode side. A catalyst is placed both on the cathode and anode side and on top of these, a Gas Diffusion Layer (GDL) is placed, which acts to remove produced water, assist diffusion of oxygen to the reaction sites and conduct electrons from the reaction sites. At last, electrically conductive bipolar plates transport fuel and oxidant to the reaction sites.

Typically fuel cells are cooled pumping either a liquid or gas through what is termed the cooling plates placed in between the anode and cathode bipolar plates. Typically, if the heat generated by the stack is going to be utilized for heating purposes, the fuel cell will be liquid cooled. On the other hand, if the fuel cell is used for APU (Auxiliary Power Unit) or other mobile power applications, the heat is rejected to the surroundings. This invention primarily relates to the first case, where the fuel cell waste heat can be used for heating purposes such as in Combined Heat and Power plants (CHP's).

### DESCRIPTION/SUMMARY OF THE INVENTION

It is therefore the object of the invention to provide a fuel cell for heating purposes and electricity production, which is simple in construction.

This purpose is achieved with a hydrogen fuel cell, for example a PEM fuel cell, with channels through the fuel cell for transport of a cooling fluid through the fuel cell wherein the channels are configured for convection driven motion of the cooling fluid through the channels. Even though the convection effect could be combined with driving force by a fluid pump, it is preferred that the fuel cell is arranged for cooling by cooling fluid that is only convention driven through the channels.

The advantage of the invention is that no pump is required to circulate the cooling water, nor valves, temperature transmitters etc. which simplifies the system and reduces costs in comparison with prior art systems. In fact, the fuel cell temperature is automatically controlled as well as the temperature difference between inlet and outlet of fuel the cell coolant. Moreover, the fuel cell is significantly compacter due to exclusion of external pumps, pipes etc.

In a practical embodiment, this can be achieved, if the channels are arranged in an inclining orientation for convection driven motion of the cooling fluid through the channels. For example, the channels may be arranged vertically.

In a certain embodiment, there is provided a cooling fluid circuit from one end of a channel to the opposite end of a channel, implying a re-circulation of the fluid through the channels. Such a circuit may, optionally, be in thermal contact with a central heating liquid in a low temperature part of the fluid circuit for transfer of thermal energy to the central heating liquid and in thermal contact with a hot tap water supply in a high temperature part of the fluid circuit for transport of thermal energy to the tap water. Alternatively, the cooling fluid circuit is in thermal contact with a central heating liquid in a low temperature part of the fluid circuit for transfer of thermal energy to the central heating liquid, in thermal contact with a hot tap water supply in a medium temperature part of the fluid circuit for transport of thermal energy to the tap water, and in thermal contact with ventilation air in a high temperature part of the fluid circuit for transfer of thermal energy to the ventilation air.

Instead of a direct thermal contact between the cooling fluid circuit and optional central heating, tap water supply and/or air ventilation, there may be provided an intermediate liquid reservoir. For this and other reasons, according to another embodiment, the cooling fluid circuit is in thermal contact with separate liquid reservoir, for example a water tank, at least partly surrounding the fuel cell. Such a water tank may, optionally, have a cold water inlet and a hot water outlet. An additional advantage is that—due to the heat capacity of the reservoir—the fuel cell is always operating within the optimum temperature range, and does not need any startup phase where the fuel cell is heated first.

Optionally, the cooling fluid may be water, though in many instances, it is of advantage, if the cooling fluid has at least on of the following properties,
a boiling point higher than for water,
a viscosity higher than for water,
a change of density per degree of change in temperature higher than for water,
an electrical conductivity lower than for water
a non-corrosive nature.

The invention has the following advantages over existing technology:

1. The system is inherently simplified as no pump is required to circulate the cooling water, nor valves, temperature transmitters etc.
2. The Control system is simplified as the fuel cell temperature is automatically controlled as well as the temperature difference between inlet and outlet of fuel cell.
3. The fuel cell is always operating within the optimum temperature range, and does not need any startup phase where the fuel cell is heated.
4. As the fuel cell stack is placed inside the hot water reservoir all heat emission is transferred to the hot water reservoir if heating and saturation of reactant gases is neglected resulting in a cooling efficiency close to 100%.
5. The system will be significantly compacter due to exclusion of external pumps, pipes etc.
6. The total system price is expected to be much lower than that of existing technology for the above reasons.

### SHORT DESCRIPTION OF THE DRAWINGS

The invention will be explained in more detail with reference to the drawing, where

FIG. 1 is an illustration of a single PEM Cell showing the central elements of the bipolar plates and the cooling plates, gas diffusion layer, catalyst layer and electrolyte,

FIG. 2 shows a cooling jacket, wherein the coolant is passively re-circulated,

FIG. 3 shows the cooling jacket inserted to a heat reservoir, where the cooling jacket transfers heat from compartment “A” to “B”,

FIG. 4 illustrates the fuel cell inserted directly into the reservoir,

FIG. 5 shows simulation results of the temperature distribution between compartment “A” and “B” as defined in FIG. 4.

### DETAILED DESCRIPTION/PREFERRED EMBODIMENT

The following contemplates a method of cooling a fuel cell stack while simultaneously being able to reuse the waste heat produced by the stack by means of natural convection in the coolant reservoir.

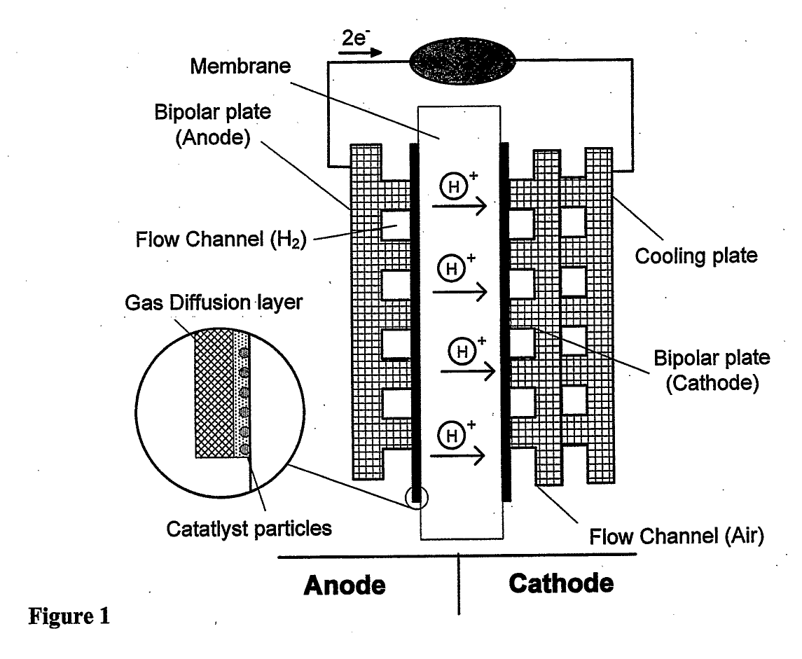

FIG. 1 shows the principle layout of a PEM fuel cell. Fuel and oxidant are transferred to the cell through channels in what is usually referred to as bipolar plates. The reactants are transferred to the catalyst layer through the gas diffusion layer (GDL), which also conducts electrons and transports water to the flow channels. The membrane conducts protons from the anode to the cathode catalyst layer. Electrons are transferred from the anode to the cathode through an external load from the anode recombining them with the protons and oxygen at the cathode to produce water. Usually more cells are connected in series in order to produce a higher output voltage. This plurality of cells is usually named a fuel cell stack. As the fuel cell produces heat as a by-product, a cooling plate is usually needed.

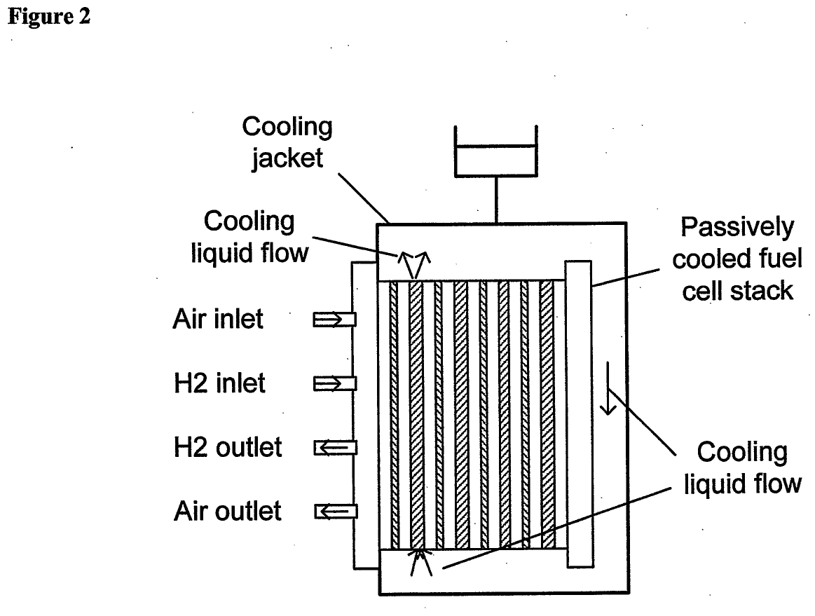

FIG. 2 shows the basic operating principle of the passive recirculation. The present invention uses natural convection trough the cooling channels to circulate cooling liquid inside a heat reservoir. The natural convection is caused by the heating of liquid, like water, which decreases the density of the liquid and thereby causes the hot liquid to move upwards, while cold water from the reservoir is sucked in at the bottom of the cooling channel. The natural convection, which causes the cooling liquid to circulate, is hereafter referred to as passive recirculation of cooling liquid.

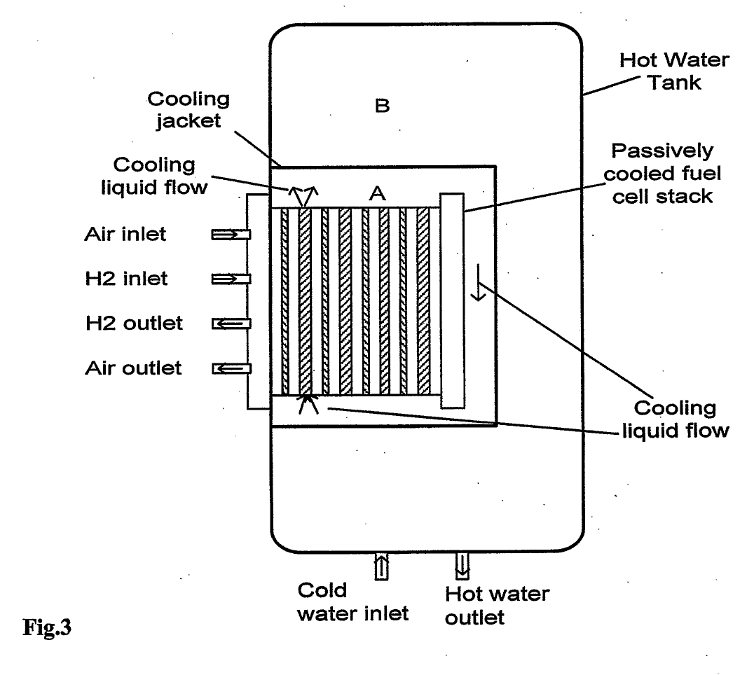

FIG. 3 shows a system where the invention of FIG. 2 is inserted into a liquid reservoir. The liquid inside the inner jacket “A” transfers the heat to the outer liquid reservoir “B”. The liquids would typically be different, where the one in “B” may be fresh water. In “A”, it would typically be a liquid with a high boiling point, high viscosity, high change of density per degree of change in temperature, low electrical conductivity and a non-corrosive nature.

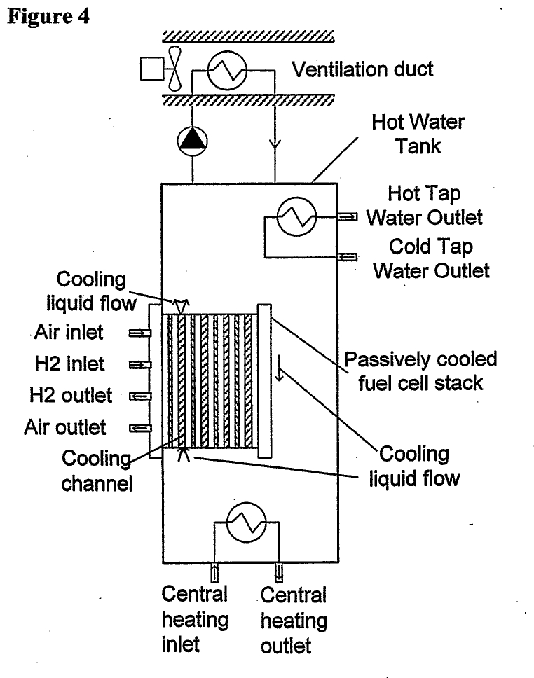

FIG. 4 shows an illustration where the inner jacket is left out, and, instead, heat exchangers are inserted into the heat reservoir. The liquid should have the same properties as the fluid inside “A” in FIG. 3. The heat reservoir will have a working temperature equivalent to that of the fuel cell type used. As only natural convection exists inside the reservoir, the liquid circulates very slowly. This will produce a very high temperature difference from top to bottom of the container. Hence the bottom could have a heat exchanger for the central heating system, one for hot water in the middle and one for the ventilation system in the top. This would produce very high temperature differences in a water/air heat exchanger, making the heat exchanger very compact. The present invention could also be arranged such that the fuel cell is placed outside the heat reservoir. This would however limit some of the advantages of the current invention.

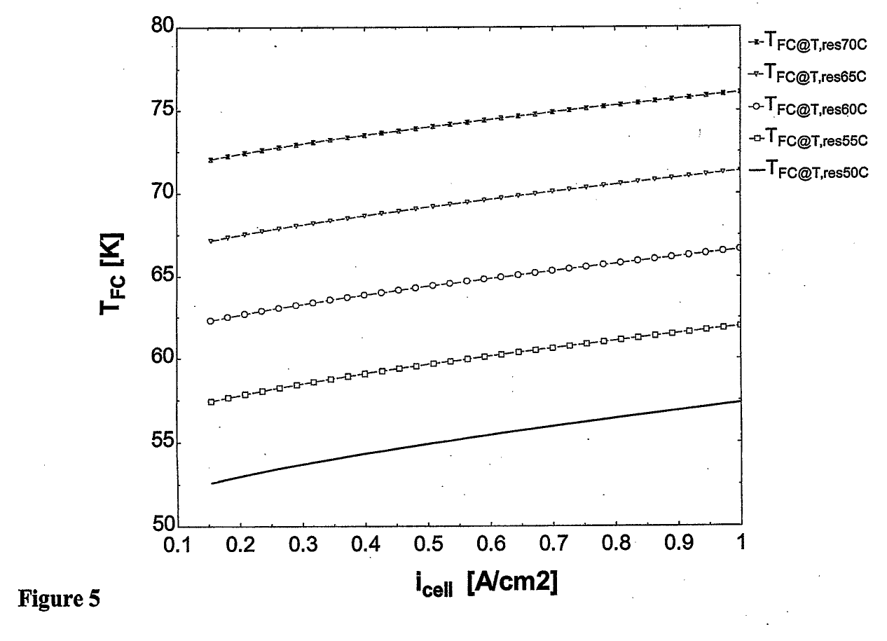

FIG. 5 shows simulation results for the fluid temperature in the cooling channel versus the current density of the fuel cell. It shows that the temperature difference between the stack and the heat reservoir newer exceeds 7° C. It is also clear that the fuel and water temperatures will be almost linearly dependent at a particular fixed current density (i.e. the electrical load applied to the fuel cell stack). The heat flux generated by the fuel cell is based on actual single cell measurements. The major assumptions of the model include: conductivity of the fuel cell, differences in local current density as well as condensing and evaporation issues.

The description of the preferred construction of the fuel cell is for illustrative purposes only and should not be limiting for the invention, application or uses.

1. A hydrogen fuel cell system comprising a hydrogen fuel cell having channels through the fuel cell for transport of a cooling fluid through the fuel cell;
wherein the channels allow for convection driven motion of the cooling fluid through the channels;
said channels comprise a cooling fluid circuit extending from one end of a channel to the opposite end of a channel;
wherein the fuel cell is inserted into a heat reservoir in the form of a tank;
wherein the channels as well as the heat reservoir comprise a cooling fluid;
wherein the cooling fluid is a liquid; and
wherein during operation of the fuel cell, heat can be transferred by the cooling fluid from the fuel cell to the heat reservoir by means of a recirculating flow of the cooling fluid established within the tank but outside the fuel cell from one end of a channel to the opposite end of a channel through the tank's interior and from the opposite end of said channel to the one end of said channel through the fuel cell's interior.

2. A hydrogen fuel cell system comprising a hydrogen fuel cell having channels through the fuel cell for transport of a cooling fluid through the fuel cell;
wherein the channels allow for convection driven motion of the cooling fluid through the channels;
said channels comprise a cooling fluid circuit extending from one end of a channel to the opposite end of a channel in the form of a cooling jacket;
said cooling jacket at least partly surrounds the fuel cell;
wherein the cooling jacket comprising the fuel cell is inserted into a heat reservoir in the form of a tank;
wherein the channels as well as the cooling jacket comprise a cooling fluid;
wherein the cooling fluid is a liquid;
wherein the heat reservoir itself contains a liquid; and
wherein during operation of the fuel cell, heat can be transferred from the fuel cell to the heat reservoir by means of the cooling fluid flowing in the cooling jacket by means of a recirculating flow of the cooling fluid established within the cooling jacket but outside the fuel cell from one end of a channel to the opposite end of a channel through the cooling jacket's interior and from the opposite end of said channel to the one end of said channel through the fuel cell's interior.

3. A hydrogen fuel cell system according to claim 1, wherein the heat reservoir is a water tank having a cold water inlet and a hot water outlet.

4. A hydrogen fuel cell system according to claim 1, wherein the cooling fluid is water.

5. A hydrogen fuel cell system according to claim 1, wherein the cooling fluid has a boiling point higher than for water.

6. A hydrogen fuel cell system according to claim 1, wherein the cooling fluid has a viscosity higher than for water.

7. A hydrogen fuel cell system according to claim 1, wherein the cooling fluid has a change of density per degree of change in temperature higher than for water.

8. A hydrogen fuel cell system according to claim 1, wherein the cooling fluid has a electrical conductivity lower than for water.

9. A hydrogen fuel cell system according to claim 1, wherein the cooling fluid has a non-corrosive nature.

10. A hydrogen fuel cell system according to claim 1, wherein the fuel cell is a PEM fuel cell.
